(19) United States
(12) Patent Application Publication
(10) Pub. No.: US 2019/0290950 A1
(43) Pub. Date: Sep. 26, 2019

(54) VERMICULITE BASED FIRE SUPPRESSION AGENT

(71) Applicant: Kidde Technologies, Inc., Wilson, NC (US)

(72) Inventors: Harlan Hagge, Knightdale, NC (US); Terry Simpson, Wake Forest, NC (US); Adam Chattaway, Berkshire (GB)

(21) Appl. No.: 15/935,620

(22) Filed: Mar. 26, 2018

(51) Int. Cl. A62D 1/00

(52) U.S. Cl. CPC A62D 1/005; A62C 3/08

(57) ABSTRACT

A fire suppression agent includes a non-aqueous pressurized fluid medium and vermiculite particles suspended in the fluid medium. The fire suppression agent is capable of suppressing a fire including a combustible metal material.

### BACKGROUND

Liquid and compressed gas fire suppression agents are effective for fighting various classes of fires, such as class A (combustible nonmetal solids), class B (combustible fluids) and class C (electrical) fires. These agents are not, however, useful for class D (combustible metal) fires. Class D fires burn at extremely high temperatures, and can react violently with liquid and compressed gas agents. Therefore, extinguishing a class D fire typically requires specially-developed dry powder agents, such as graphite or sodium chloride, to smother and deprive the fire of oxygen, as well as absorb heat. Class D extinguishers, however, may not be effective at fighting class A-C fires.

A commercial aircraft is one setting at risk for multiple classes of fire, especially given the recent prevalence of lithium battery fires caused by personal electronic devices. Federal regulations require fire extinguishers and fixed fire systems throughout the aircraft, and they often contain different fire suppression agents based on the most likely type or types of fire in that space. A single fire suppression agent suitable for use with multiple classes of fire may be more effective and economical.

### SUMMARY

A fire suppression agent includes a non-aqueous pressurized fluid medium and vermiculite particles suspended in the fluid medium. The fire suppression agent is capable of suppressing a fire including a combustible metal material.

An aircraft fire suppression system includes a vessel and a fire suppression agent contained within the vessel. The fire suppression agent includes a non-aqueous pressurized fluid medium and vermiculite particles suspended in the fluid medium. The fire suppression agent is capable of suppressing a fire including a combustible metal material.

A method of making a fire suppression agent suitable for suppressing a fire including a combustible metal material includes suspending an amount of the vermiculite particles in a non-aqueous pressurized fluid medium.

### BRIEF DESCRIPTION OF THE DRAWINGS

FIG. 1 is simplified illustration of a fire suppression agent, and a system employing the fire suppression agent.

FIG. 2 is a simplified illustration of an alternative embodiment of a system employing the fire suppression agent.

### DETAILED DESCRIPTION

The present invention is directed to a hybrid fire suppression agent and a system employing the fire suppression agent. The fire suppression agent includes vermiculite particles suspended in a liquid or liquefied compressed gas agent. Vermiculite is a naturally-occurring, mineral that, when raw, consists of thin flakes with microscopic layers of water. Raw vermiculite can be exfoliated and suspended in a solution. The vermiculite can be effective at fighting class D fires, and those involving lithium batteries. When combined with the liquid agent, the hybrid agent can be used to fight multiple classes of fires.

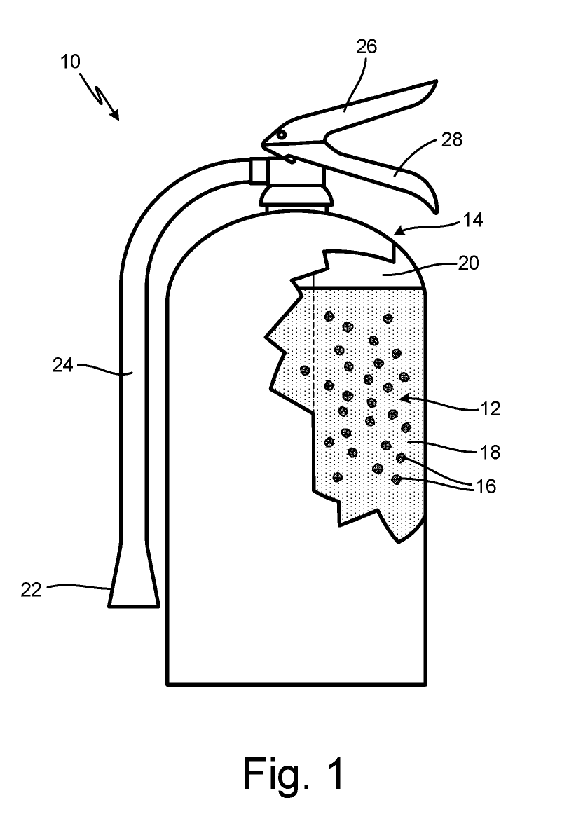

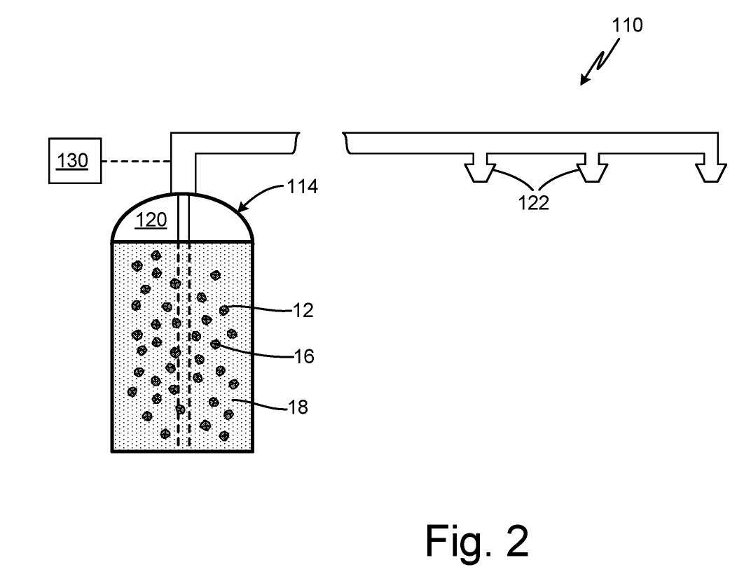

FIGS. 1 and 2 are simplified illustrations of portable and fixed fire suppression systems 10 and 110, respectively. Fire suppression systems 10 and 110 include hybrid fire suppression agent 12 contained within vessels 14 and 114. Fire suppression agent 12 includes vermiculite particles 16 suspended in fluid medium 18. Vermiculite particles 16 can range from about 1 micron to 300 microns in diameter. In an exemplary embodiment, the Dv90 diameter (the diameter of particles occupying 90% of the total volume) is less than 200 microns, while the Dv50 diameter (median diameter) is less than 85 microns. Further, the concentration of vermiculite particles 16 within fire suppression agent 12 ranges from about 5% to 40% by weight, and in an exemplary embodiment, from about 13% to 20% by weight. Other particle diameter distributions and concentrations are possible, and can vary based on, for example, specific fire suppression needs, system parameters, and to prevent settling of vermiculite particles 16.

Fluid medium 18 can be a non-aqueous, liquid or a liquefied compressed gas fire suppression agent and can include, for example, fluorocarbons and halocarbons. Exemplary agents can include one or a combination of 2-BTP (2-bromo-3,3,3-trifluoropropene), HFC-236fa (1,1,1,3,3,3-hexafluoropropane), HFC-125 (pentafluoroethane), HFC-227ea (1,1,1,2,3,3,3-heptafluoropropane), Novec 1230 (C₆F₁₂O), and trifluoromethyliodide (CF₃I). In an alternative embodiment, fluid medium 18 can be a mixture of one of the aforementioned and carbon dioxide. For example, fluid medium 18 can be a mixture of 2-BTP and carbon dioxide. Other agents and combinations of agents are contemplated herein, and may be selected based on fire suppression needs and vermiculite compatibility.

In the embodiment shown in FIG. 1, vessel 14 is a pressure vessel and is configured as a portable (e.g., handheld) extinguisher. Vessel 14 includes inner volume 20 which can be partially or fully occupied by fire suppression agent 12. Vessel 14 further includes nozzle 22 connected to hose 24, handle 26, and lever 28. Fire suppression agent 12 can be discharged through hose 24 and nozzle 22 via actuation of lever 28. Nozzle 22 can also be configured without hose 24, and can further include any tap, valve, or port suitable for placing inner volume 20 in fluid communication with the environment.

In the embodiment of FIG. 2, vessel 114 is arranged as a storage tank for fixed fire suppression system 110 (e.g., a cargo bay fire suppression system) configured to discharge fire suppression agent 12 into an enclosed space via one or more nozzles 122. Similar to vessel 14, vessel 114 includes inner volume 120 which can be partially or fully occupied by fire suppression agent 12. Fire suppression system 110 can further include one or more sensors 130 for detecting a fire and/or automatically discharging fire suppression agent 12. Exemplary sensors can include one or a combination of smoke detectors, thermal sensors, ultraviolet sensors, and infrared sensors. Although shown with only a single vessel 114, alternative embodiments can include two or more vessels 114.

In exemplary embodiments of systems 10 and 110, fire suppression agent 12 is added to vessels 14, 114 first by placing an amount of vermiculite particles 16 into an empty inner volume 20, sealing vessel 14, and adding a desired volume fluid medium 18 under pressure. In alternative embodiments of systems 10 and 110, vermiculite particles 16 can be stored separately from fluid medium 18 until triggered to mix upon or just before discharge. Such a separate storage configuration can help extend the shelf life of vermiculite particles 16 and/or fluid medium 18, as well as to prevent potential degradation of any compound within fire suppression agent 12.

The disclosed fire suppression agent and systems have many benefits. The vermiculite particles allow the agent to extinguish class D fires and fires involving lithium batteries, while the fluid component can be effective against other classes (A-C) of fire. Besides commercial aircraft, the disclosed fire suppression agent and system can be used in private and cargo aircraft, other transportation industries (e.g., automotive, maritime, etc.), factories, laboratories, and more.

### Discussion of Possible Embodiments

The following are non-exclusive descriptions of possible embodiments of the present invention.

A fire suppression agent includes a non-aqueous pressurized fluid medium and vermiculite particles suspended in the fluid medium. The fire suppression agent is capable of suppressing a fire including a combustible metal material.

The fire suppression agent of the preceding paragraph can optionally include, additionally and/or alternatively, any one or more of the following features, configurations and/or additional components:

In the above fire suppression agent, a concentration of the vermiculite particles can range from 5% to 40% by weight.

In any of the above fire suppression agents, a Dv90 diameter of the vermiculite particles can be less than 200 microns.

In any of the above fire suppression agents, a Dv50 diameter of the vermiculite particles can be less than 85 microns.

In any of the above fire suppression agents, the non-aqueous pressurized fluid medium can include a compound selected from the group consisting of 2-BTP, HFC-236fa, HFC-125, HFC-227ea, Novec 1230, trifluoromethyliodide, carbon dioxide, and combinations thereof.

Any of the above fire suppression agents can further be capable of suppressing a fire comprising at least one of: a combustible non-metal solid, a combustible fluid, and an electrical component.

An aircraft fire suppression system includes a vessel and a fire suppression agent contained within the vessel. The fire suppression agent includes a non-aqueous pressurized fluid medium and vermiculite particles suspended in the fluid medium. The fire suppression agent is capable of suppressing a fire including a combustible metal material.

The fire suppression system of the preceding paragraph can optionally include, additionally and/or alternatively, any one or more of the following features, configurations and/or additional components:

The above system can further be capable of suppressing a fire comprising at least one of: a combustible non-metal solid, a combustible fluid, and an electrical component.

Any of the above systems can further include a nozzle for selectively discharging the fire suppression agent.

Any of the above systems can further include a sensor configured to detect a fire.

In any of the above systems, the sensor can be one of a smoke detector, thermal sensor, ultraviolet sensor, and infrared sensor.

In any of the above systems, the vessel can be portable.

In any of the above systems, the vessel can be incorporated into a fixed fire suppression system.

In any of the above systems, the vessel can be incorporated into a fixed fire suppression system.

In any of the above systems, a concentration of the vermiculite particles can range from 5% to 40% by weight.

In any of the above systems, the non-aqueous pressurized fluid medium can include a compound selected from the group consisting of 2-BTP, HFC-236fa, HFC-125, HFC-227ea, Novec 1230, trifluoromethyliodide, carbon dioxide, and combinations thereof.

A method of making a fire suppression agent suitable for suppressing a fire including a combustible metal material includes suspending an amount of the vermiculite particles in a non-aqueous pressurized fluid medium.

The method of the preceding paragraph can optionally include, additionally and/or alternatively, any one or more of the following features, configurations and/or additional components:

In the above method, a concentration of the vermiculite particles can range from 5% to 40% by weight.

In any of the above methods, the non-aqueous pressurized fluid medium can include a compound selected from the group consisting of 2-BTP, HFC-236fa, HFC-125, HFC-227ea, Novec 1230, trifluoromethyliodide, carbon dioxide, and combinations thereof.

Any of the above methods can further be capable of suppressing a fire comprising at least one of: a combustible non-metal solid, a combustible fluid, and an electrical component.

Any of the above methods can further include adding the fire suppression agent to a vessel to form a fire suppression system.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fire suppression agent comprising:
a non-aqueous pressurized fluid medium; and
vermiculite particles suspended in the fluid medium;
wherein the fire suppression agent is capable of suppressing a fire comprising a combustible metal material.

2. The fire suppression agent of claim 1, wherein a concentration of the vermiculite particles ranges from 5% to 40% by weight.

3. The fire suppression agent of claim 1, wherein a Dv90 diameter of the vermiculite particles is less than 200 microns.

4. The fire suppression agent of claim 1, wherein a Dv50 diameter of the vermiculite particles is less than 85 microns.

5. The fire suppression agent of claim 1, wherein the non-aqueous pressurized fluid medium comprises a compound selected from the group consisting of 2-BTP, HFC-236fa, HFC-125, HFC-227ea, Novec 1230, trifluoromethyliodide, carbon dioxide, and combinations thereof.

6. The fire suppression agent of claim 1, wherein the fire suppression agent is further capable of suppressing a fire comprising at least one of:
a combustible nonmetal solid;
a combustible fluid; and
an electrical component.

7. An aircraft fire suppression system comprising:
a vessel; and
a fire suppression agent contained within the vessel, the fire suppression agent comprising:
a non-aqueous pressurized fluid medium; and
vermiculite particles suspended in the fluid medium;
wherein the fire suppression agent is capable of suppressing a fire comprising a combustible metal material.

8. The system of claim 7, wherein the fire suppression agent is further capable of suppressing a fire comprising at least one of:
a combustible nonmetal solid;
a combustible fluid; and
an electrical component.

9. The system of claim 7 and further comprising: a nozzle for selectively discharging the fire suppression agent.

10. The system of claim 7 and further comprising: a sensor configured to detect a fire.

11. The system of claim 10, wherein the sensor is one of a smoke detector, thermal sensor, ultraviolet sensor, and infrared sensor.

12. The system of claim 7, wherein the vessel is portable.

13. The system of claim 7, wherein the vessel is incorporated into a fixed fire suppression system.

14. The system of claim 7, wherein a concentration of the vermiculite particles ranges from 5% to 40% by weight.

15. The system of claim 7, wherein the non-aqueous pressurized fluid medium comprises a compound selected from the group consisting of 2-BTP, HFC-236fa, HFC-125, HFC-227ea, Novec 1230, trifluoromethyliodide, carbon dioxide, and combinations thereof.

16. A method of making a fire suppression agent suitable for suppressing a fire comprising a combustible metal material, the method comprising: suspending an amount of vermiculite particles in a non-aqueous pressurized fluid medium.

17. The method of claim 16, wherein a concentration of the vermiculite particles ranges from 5% to 40% by weight.

18. The method of claim 16, wherein the non-aqueous pressurized fluid medium comprises a compound selected from the group consisting of 2-BTP, HFC-236fa, HFC-125, HFC-227ea, Novec 1230, trifluoromethyliodide, carbon dioxide, and combinations thereof.

19. The method of claim 16, wherein the fire suppression agent is further capable of suppressing a fire comprising at least one of:
a combustible nonmetal solid;
a combustible fluid; and
an electrical component.

20. The method of claim 16 and further comprising: adding the fire suppression agent to a vessel to form a fire suppression system.
